(19) United States
(12) Patent Application Publication
(10) Pub. No.: US 2015/0154442 A1
(43) Pub. Date: Jun. 4, 2015

(54) HANDWRITING DRAWING APPARATUS AND METHOD

(71) Applicant: Kabushiki Kaisha Toshiba, Tokyo (JP)

(72) Inventors: Shihomi Takahashi, Yokohama Kanagawa (JP); Toshiaki Nakasu, Tokyo (JP); Tomoyuki Shibata, Kawasaki Kanagawa (JP); Kazunori Imoto, Kawasaki Kanagawa (JP); Yojiro Tonouchi, Inagi Tokyo (JP); Yasunobu Yamauchi, Yokohama Kanagawa (JP)

(21) Appl. No.: 14/616,579

(22) Filed: Feb. 6, 2015

Related U.S. Application Data
(63) Continuation of application No. PCT/JP2013/071992, filed on Aug. 9, 2013.

(30) Foreign Application Priority Data
Aug. 10, 2012 (JP) 2012-178938

(51) Int. Cl. G06K 9/00; G06F 3/01

(52) U.S. Cl. CPC G06K 9/00416; G06F 3/017

(57) ABSTRACT

According to one embodiment, a handwritten document processing apparatus is provided with a stroke acquisition unit, a stroke group generation unit and a hierarchical relation determination unit. The stroke acquisition unit acquires stroke data. The stroke group generation unit generates stroke groups each including one or a plurality of strokes, which satisfy a predetermined criterion, based on the stroke data. The hierarchical relation determination unit determines a hierarchical relation of a plurality of stroke groups so as to generate layer information.

### CROSS-REFERENCE TO RELATED APPLICATIONS

This application is a Continuation Application of PCT Application No. PCT/JP2013/071992, filed Aug. 9, 2013 and based upon and claiming the benefit of priority from Japanese Patent Application No. 2012-178938, filed Aug. 10, 2012, the entire contents of all of which are incorporated herein by reference.

### FIELD

Embodiments described herein relate to a handwriting drawing apparatus and method.

### BACKGROUND

A document processing apparatus, which determines an overlapping state of a plurality of objects, shapes of which are specified in advance, is known.

### BRIEF DESCRIPTION OF THE DRAWINGS

FIG. 1 is an exemplary block diagram showing a handwriting drawing apparatus according to an embodiment;

FIGS. 2 and 3 are exemplary flowcharts showing various processings of the handwriting drawing apparatus;

FIG. 4 is a view illustrating an example of a format of ink data;

FIG. 5 is a view for illustrating the input of stroke data;

FIG. 6 is a view relevant to handwritten objects for illustrating attributes and layers;

FIG. 7 is a view illustrating an example of a format of stroke group data;

FIG. 8 is an exemplary flowchart illustrating a processing of the handwriting drawing apparatus;

FIG. 9 is a view illustrating an example of a format of layer information;

FIGS. 10-14 are views relevant to handwritten objects for illustrating various examples of layer processing;

FIGS. 15 and 16 are exemplary flowcharts illustrating various processings of the handwriting drawing apparatus;

FIGS. 17-24 are views relevant to handwritten objects for illustrating various examples of processing of a layer stroke group;

FIG. 25 is an exemplary block diagram showing a hardware arrangement; and

FIG. 26 is a view for describing an exemplary configuration in which a network is involved.

### DETAILED DESCRIPTION

Details of a handwriting drawing apparatus according to an embodiment of the present invention will be described hereinafter with reference to the drawings. Note that components denoted by the same reference numerals in the following embodiment perform the same operations, and a repetitive description thereof will be avoided.

According to one embodiment, a handwritten document processing apparatus is provided with a stroke acquisition unit, a stroke group generation unit and a hierarchical relation determination unit. The stroke acquisition unit acquires stroke data. The stroke group generation unit generates stroke groups each including one or a plurality of strokes, which satisfy a predetermined criterion, based on the stroke data. The hierarchical relation determination unit determines a hierarchical relation of a plurality of stroke groups so as to generate layer information.

According to this embodiment, objects can be processed in consideration of a hierarchical relation between a plurality of handwritten objects.

In the following description, practical handwritten character examples use mainly Japanese handwritten character examples. However, this embodiment is not limited to Japanese handwritten characters, and is applicable to mixed handwritten characters of a plurality of languages.

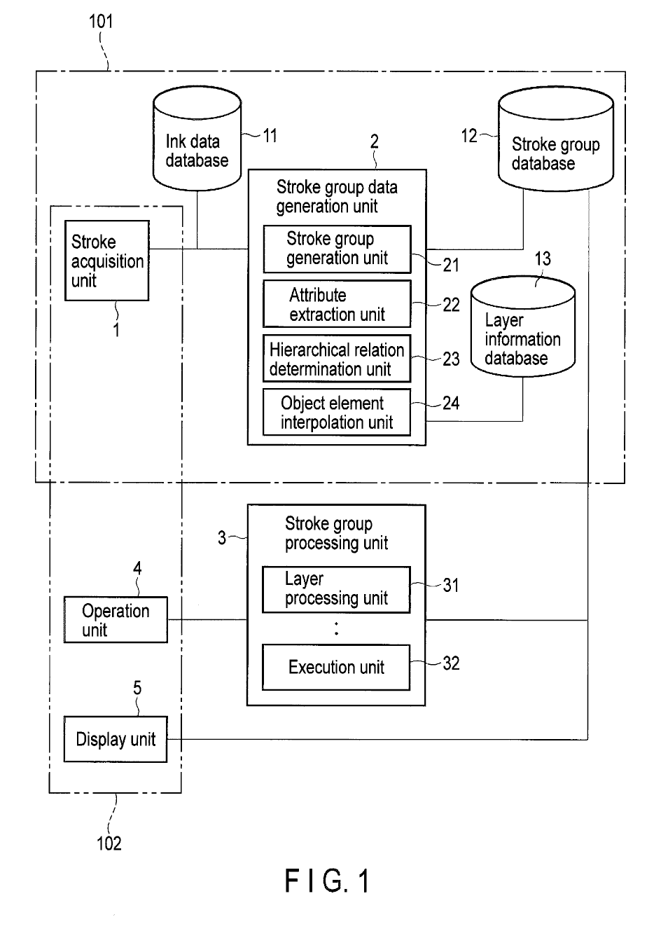

FIG. 1 shows an example of the arrangement of a handwriting drawing apparatus according to this embodiment. As shown in FIG. 1, the handwriting drawing apparatus of this embodiment includes a stroke acquisition unit 1, stroke group data generation unit 2, stroke group processing unit 3, operation unit 4, display unit 5, ink data database 11, stroke group database 12, and layer information database 13.

The stroke acquisition unit 1 acquires strokes. Note that the stroke refers to a stroke (e.g., one pen stroke or one stroke in a character) which has been input by handwriting. More specifically, a stroke represents a locus of a pen or the like from the contact of the pen or the like with an input surface to the release thereof. The stroke can use a locus which records coordinates having a predetermined position as an origin, a locus which is written on a touch panel type input surface by a pen, finger, or the like, or a handwritten locus on paper may be recorded and used.

The ink data database 11 stores ink data in which strokes are put together in a predetermined unit. The predetermined unit indicates a page, document, or the like set on an electronic apparatus.

The stroke group data generation unit 2 generates data of stroke groups from the ink data. Also, the stroke group data generation unit 2 generates layer information indicating a hierarchical relation between two or more stroke groups. For example, the layer information means that when a plurality of stroke groups overlap on a display plane of a handwritten document, a stroke group closer to the display plane is located at a higher level. Note that this embodiment assumes that the layer information is held for each local hierarchical relation, but global layer information in a document may be provided in addition to or in place of the former layer information.

The stroke group database 12 stores data of individual stroke groups. One stroke group includes one or a plurality of strokes which form a group. As will be described in detail later, for example, as for a handwritten character, a line, word, or the like can be defined as a stroke group. Also, for example, as for a handwritten figure, an element figure of a flowchart, table, illustration, or the like can be defined as a stroke group. In this embodiment, a stroke group is used as a basic unit of processing. These stroke groups will be referred to as objects hereinafter.

The layer information database 13 stores layer information.

The stroke group processing unit 3 executes processing associated with a stroke group.

The operation unit 4 is operated by the user so as to execute the processing associated with a stroke group. The operation unit 4 may provide a GUI (Graphical User Interface).

The display unit 5 presents information associated with a stroke, information associated with an object, information associated with a layer, a processing result for an object, a processing result for a layer, and the like.

Note that all or some of the stroke acquisition unit 1, operation unit 4, and display unit 5 may be integrated (as, for example, a GUI).

As will be described in detail later, the stroke group data generation unit 2 may include a stroke group generation unit 21, attribute extraction unit 22, hierarchical relation determination unit 23, and object element interpolation unit 24.

Also, the stroke group processing unit 3 may include a layer processing unit 31 which executes processing (operation) associated with layers between a plurality of objects, and an execution unit 32 which executes predetermined processing for a designated object.

Note that the processing associated with a layer includes, for example:
selection from overlapping character string(s) and/or figure(s);
assignment of a hierarchical relation to overlapping character string(s) and/or figure(s);
change of a hierarchical relation of overlapping character string(s) and/or figure(s);
interpolation of an occluded portion of overlapping figures;
presentation of a hierarchical relation; and so forth (however, this embodiment is not limited to these processes).

Note that the handwriting drawing apparatus of this embedment need not always include all the elements shown in FIG. 1.

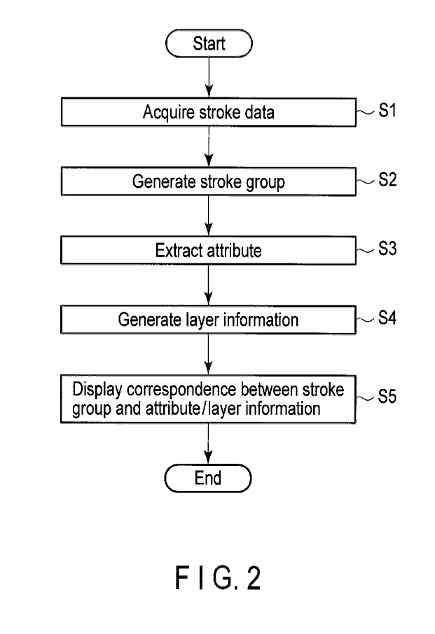

FIG. 2 shows an example of processing of the handwriting drawing apparatus of this embodiment.

In step S1, the stroke acquisition unit 1 acquires stroke data. As described above, ink data which combines stroke data for a predetermined unit may be acquired and used.

In step S2, the stroke group data generation unit 2 (stroke group generation unit 21) generates data of stroke groups from the ink data.

In step S3, the stroke group data generation unit 2 (attribute extraction unit 22) extracts an attribute.

In step S4, the stroke group data generation unit 2 (hierarchical relation determination unit 23) generates additional information.

In step 55, the display unit 5 presents correspondence between the stroke groups and the attribute/layer information.

Note that steps S2 to S4 may be executed in an order different from that described above. Also, after step S4, the stroke group data generation unit 2 (object element interpolation unit 24) may interpolate object elements.

In step S5, presentation of some data may be omitted. Also, step S5 itself may be omitted, or all or some of the stroke groups/attribute/layer information may be output to an apparatus other than a display device in place of or in addition to step S5.

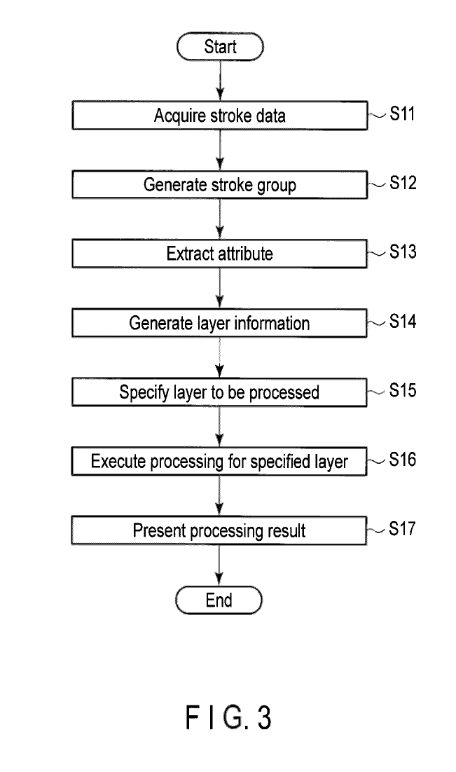

FIG. 3 shows another example of the processing of the handwriting drawing apparatus of this embodiment.

Steps S11 to S14 are the same as steps S1 to S4 in FIG. 2.

In step S15, the stroke group processing unit 3 (layer processing unit 31) specifies a layer to be processed.

In step S16, the stroke group processing unit 3 (execution unit 32) executes processing for the specified layer or that for an object corresponding to the specified layer.

In step S17, the display unit 5 presents a result of the processing.

Note that the processing result may be output to an apparatus other than a display device in place of or in addition to step S17.

Note that FIGS. 2 and 3 are examples, and various other processing sequences are available.

The stroke acquisition unit 1 and ink data database 11 will be described below.

The stroke acquisition unit 1 is used to acquire handwritten strokes.

The description below is mainly given of the case in which a stroke, which is handwritten by the user, is acquired. As the method of input by handwriting, use may be made of various methods, such as a method of input by a pen on a touch panel, a method of input by a finger on the touch panel, a method of input by a finger on a touch pad, a method of input by operating a mouse, and a method by an electronic pen.

Stroke groups, which is handwritten by the user, is stored in ink data database 11, for example, when the user finishes writing a document or saves a document. The ink data is a data structure for storing stroke groups in units of a document, etc.

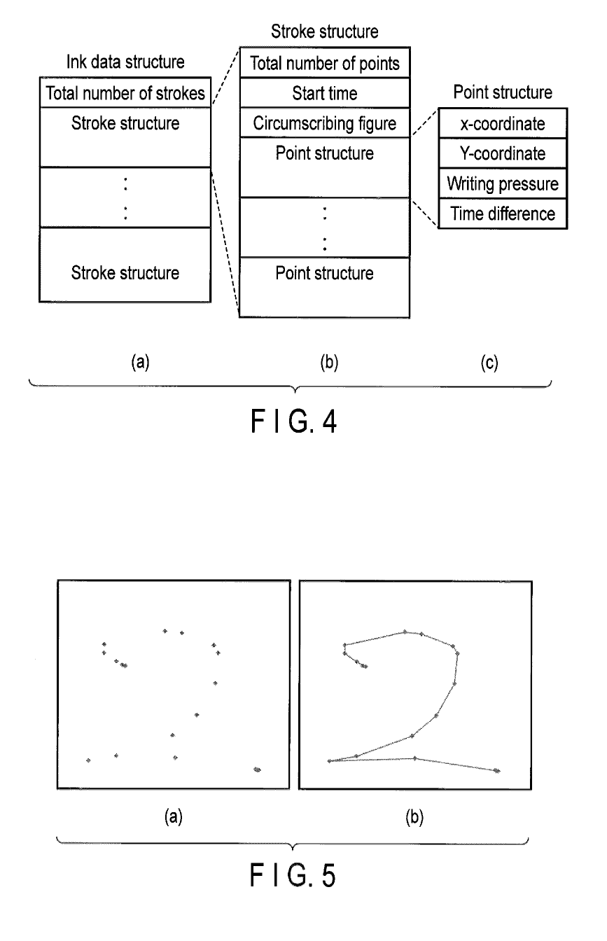

Next, referring to FIG. 4, a description is given of the data structure of ink data and the data structure of stroke data.

Usually, a stroke is sampled such that points on a locus of the stroke are sampled at a predetermined timing (e.g. at regular time intervals). Thus, the stroke is expressed by a series of sampled points.

In an example of part (b) of FIG. 4, a stroke structure of one stroke (i.e., one handwritten stroke) is expressed by a set of coordinate values (herein after called “point structure”) on a plane on which a pen has moved. Specifically, the stroke structure is a structure including “total number of points” indicative of the number of points constituting the stroke, “start time”, “circumscribed figure”, and an array of “point structures”, the number of which corresponds to the total number of points. The start time indicates a time point at which the pen was put in contact with the input surface to write the stroke. The circumscribed figure indicates a circumscribed figure for a locus of the stroke on the document plane (preferably, a rectangle of a smallest area including the stroke on the document plane).

The structure of a point may depend on an input device. In an example of part (c) of FIG. 4, the structure of one point is a structure having four values, namely coordinate values x and y, at which the point was sampled, a writing pressure, and a time difference from an initial point (e.g. the above-described “start time”).

The coordinates are a coordinate system on the document plane, and may be expressed by positive values which become greater toward a lower right corner, with an upper left corner being the origin.

In addition, when the input device is unable to acquire a writing pressure or when a writing pressure, even if acquired, is not used in a subsequent process, the writing pressure in part (c) of FIG. 4 may be omitted or data indicative of invalidity may be described for the writing pressure.

In the examples of parts (b) and (c) of FIG. 4, actual data, such as coordinate values x and y, may be described in section of each point structure in the stroke structure. Alternatively, assuming that the data of the stroke structure and the data of the point structure are separately managed, link information to the corresponding point structure may be described in the section of each point structure in the stroke structure.

FIG. 5 illustrates an example of a stroke which is acquired. In the description below, for example, the case is assumed that the sampling cycle of sample points in the stroke is constant. Part (a) of FIG. 5 shows coordinates of sampled points, and part (b) of FIG. 5 shows temporally successive point structures which are linearly interpolated. The difference in intervals of coordinates of sampling points is due to the difference in speed of writing. The number of sampling points may differ from stroke to stroke.

In an example of part (a) of FIG. 4, the data structure of ink data is a structure including “total number of strokes” indicative of the number of stroke structures included in the entire area of the document, and an array of “stroke structures”, the number of which corresponds to the total number of strokes.

In the examples of parts (a) and (b) of FIG. 4, the data of part (b) of FIG. 4 may be described in the part of each stroke structure in the ink data structure. Alternatively, assuming that the data of the ink data structure and the data structure of the stroke of part (b) of FIG. 4 are separately managed, link information to the corresponding data of part (b) of FIG. 4 may be described in the part of the data structure of each stroke in the ink data structure.

The stroke data, which has been written by the user by using the input device, is deployed on the memory, for example, by the ink data structure shown in FIG. 4. The ink data is stored as ink data database 11, for example, when the ink data is saved as a document.

Incidentally, when pluralities of documents are stored, document IDs for identifying these documents may be saved in association with each ink data. In addition, in order to identify each stroke, a stroke ID may be imparted to each stroke structure.

The stroke group data generation unit 2 (stroke group generation unit 21, attribute extraction unit 22, hierarchical relation determination unit 23, and object element interpolation unit 24) and stroke group database 12 will be described below.

The stroke group generation unit 21 generates a stroke group including one or a plurality of strokes which form a group from a handwritten document (ink data) (or it divides a plurality of strokes into objects which express “characters”, “figures”, or the like). One stroke belongs to any one of stroke groups.

Note that a predetermined criterion or stroke group generation method can be appropriately set or selected. For example, the predetermined criterion or stroke group generation method can be selected in association with “character” depending on which of a line, word, and character is set as a stroke group. Also, the predetermined criterion or stroke group generation method can be selected in association with “figure” depending on, for example, whether all ruled lines of one table are set as one stroke group or each individual ruled line (line segment) of one table is set as one stroke group. Also, the predetermined criterion or stroke group generation method can be selected depending on whether two intersecting line segments are set as one stroke group or two stroke groups. In addition, the stroke group generation method can be changed according to various purposes and the like.

Stroke groups may be generated by various methods. For example, stroke group generation processing may be executed at an input completion timing of a document for one page or for a previously input document for one page. Alternatively, for example, the user may input a generation instruction of stroke groups. Alternatively, the stroke group generation processing may be started when no stroke has been input for a predetermined time period. Alternatively, when strokes were input to a certain region, processing for generating stroke groups in that region may be started when no stroke has been input for a predetermined time period within a predetermined range from that region.

The attribute extraction unit 22 extracts an attribute unique to each individual stroke group. The extracted attribute is given to that stroke group. The attribute is, for example, “character” or “figure”. Another example of the attribute is “table”, “illustration”, “mathematical expression”, or the like.

Note that the stroke group generation unit 21 and attribute extraction unit 22 may be integrated. That is, a method of simultaneously obtaining a stroke group and attribute may be used.

As the stroke group generation method, various methods can be used.

For example, the following methods can be used.

(1) A set of one or plurality of strokes input within a predetermined time period is defined as one stroke group.

(2) A set of one or a plurality of strokes having inter-stroke distances which are not more than a predetermined threshold is defined as one stroke group. The inter-stroke distance is, for example, a distance between barycenters of stroke positions or a distance between barycentric points of figures which circumscribe strokes (for example, a polygon such as a rectangle, a circle, an ellipse, or the like).

(3) By focusing attention on neighboring line segment structures, element groups which form basic figures as a basis upon creation of a figure are extracted from the number of vertices of strokes and the types of line segments between consecutive vertices, and the extracted basic figures are separated into stroke groups each of which forms one figure based on their relative positional relationship (for example, see Haruhiko Kojima: On-line Hand-sketched Line Figure Input System by Adjacent Strawks Structure Analysis Method, Information Processing Society of Japan Technical Report Human-computer Interaction 26, pp. 1-9, (1986)).

(4) A method which combines some or all of these methods.

The above methods are examples, and the available stroke group generation method is not limited to them. Also, a known method may be used.

Note that a stroke group may be extended in a chain reaction manner. For example, when strokes a and b satisfy a condition of one stroke group, and when strokes b and c satisfy the condition of one stroke group, strokes a, b, and c may define one stroke group irrespective of whether strokes a and c satisfy the condition of one stroke group.

For an isolated stroke, the isolated stroke itself may be handled as one stroke group.

The attribute extraction unit 22 extracts an attribute unique to each individual generated stroke group.

Various attribute extraction methods are available.

For example, the attribute extraction unit 22 applies character recognition to a stroke group, and determines based on its likelihood whether or not that stroke group is a character. When it is determined that the stroke group is a character, the attribute extraction unit 22 may set “character” as the attribute of that stroke group. Likewise, for example, the attribute extraction unit 22 applies figure recognition to a stroke group, and determines based on its likelihood whether or not that stroke group is a figure. When it is determined that the stroke group is a figure, the attribute extraction unit 22 may set “figure” as the attribute of that stroke group. Alternatively, for example, the attribute extraction unit 22 may prepare for a rule [e.g., a attribute of a stroke group including a stroke having a stroke length not less than a threshold is set as “figure”], and may apply that rule.

Note that as for handling of a stroke group which is not recognized as “character” or “figure”, various methods may be used. To a stroke group which is not recognized as “character” or “figure”, for example, a predetermined attribute (for example, “figure”) may be assigned as an attribute. Alternatively, based on surrounding stroke groups, an attribute may be estimated. For example, when most attributes of surrounding stroke groups are “character”, an attribute of that stroke group may be recognized as “character”; when most attributes of surrounding stroke groups are “figure”, an attribute of that stroke group may be recognized as “figure”. Also, for example, a rule that “an attribute of a stroke group surrounded by those having an attribute “figure” is “character”” may be prepared and applied.

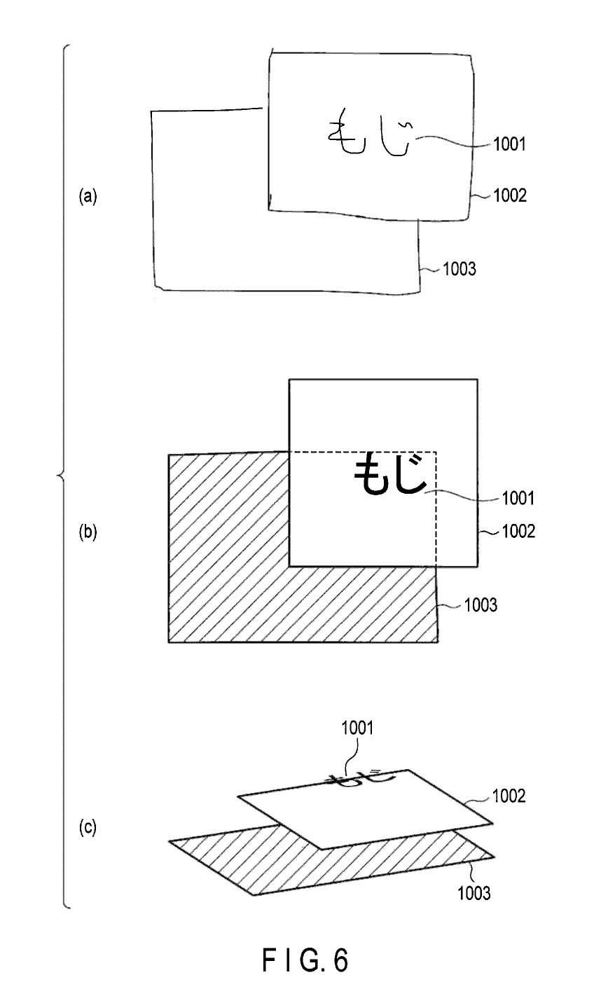

An example of stroke groups and attribute will be described below with reference to FIG. 6.

In FIG. 6, (a) shows an example of a handwritten document (stroke sequences). For example, from the stroke sequences in (a) of FIG. 6, three stroke groups 1001 to 1003 are generated, as shown in (b). An attribute “character” is assigned to the stroke group 1001 (in this handwritten text example, “ [symbol] ” (“character” or “letter” in English)), and an attribute “figure” is assigned to the stroke groups 1002 and 1003.

A data structure of a stroke group will be described below.

As the data structure of a stroke group, various structures may be used.

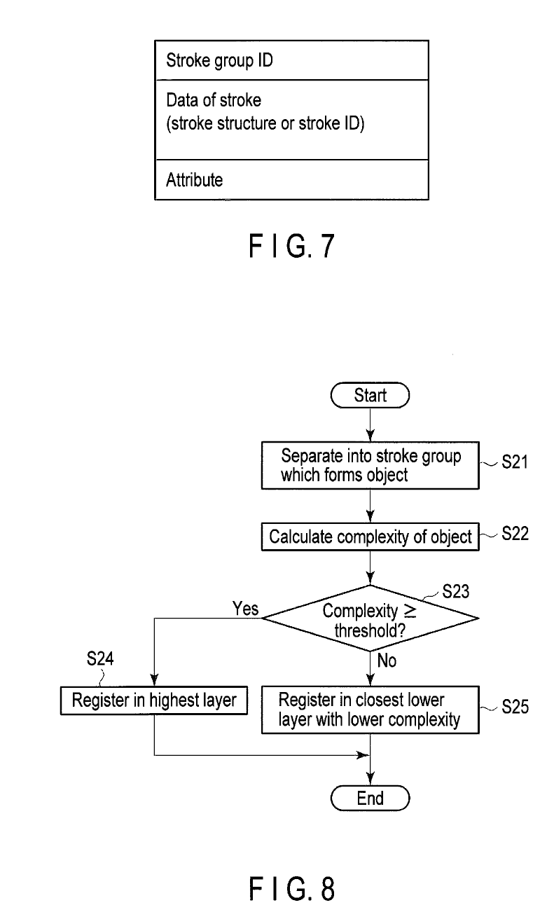

FIG. 7 shows an example of a data structure of each individual stroke group. In the example of FIG. 7, data of one stroke group includes “stroke group ID”, “data of stroke”, and “attribute”.

“Stroke group ID” (to be also referred to as “object ID” hereinafter) is an identifier used to identify a stroke group in a document of interest.

“Data of stroke” is data which allows to specify one or a plurality of strokes included in that stroke group. “Data of stroke” may hold stroke structures (see (a) in FIG. 4) corresponding to individual strokes included in that stroke group, or stroke IDs corresponding to individual strokes included in that stroke group.

At least one “attribute” is assigned to any stroke group.

Also, data of a stroke group may hold various other kinds of information. Another kind of information could be, for example, a position and/or a positional relationship of an object. Also, another attribute indicating whether or not a figure is a closed figure or the like may be included.

The hierarchical relation determination unit 23 and object element interpolation unit 24 will be described below.

The hierarchical relation determination unit 23 determines a hierarchical relation between objects in association with a plurality of stroke groups having a predetermined relation (for example, an inclusion relation or intersection relation).

For example, in the example of FIG. 6, as shown in (c), the stroke group 1003 with an attribute “character” is assigned to the highest layer, the stroke group 1002 of “closed figure” is assigned to the next layer, and the stroke group 1003 of “open figure” is assigned to the next layer.

Note that the predetermined relation includes, for example, an inclusion relation in which one stroke group is included in the other stroke group, an intersection relation in which two stroke groups partially overlap each other, a connection relation in which two stroke groups are connected to each other, and an adjacency relation in which two stroke group are adjacent to each other. Note that separately located two stroke groups have none of the above relations.

In this embodiment, a layer relation need not be handled between objects having none of the above relations.

For example, in (a) of FIG. 6, stroke data have neither a relation nor a hierarchical relation between the stroke groups 1001 and 1002. In this embodiment, overlapping states intended by the user can be reproduced by determining a hierarchical relation from, for example, likelihoods of objects and the like.

For example, when stroke data for which a shape of a target object is not specified are input, they are separated into element groups which form objects such as characters, figures, or the like. Then, an overlapping state of objects whose overlapping relation cannot be determined from strokes is determined from attributes of objects. Stroke data are input, and are separated into stroke groups each of which forms one object such as a character or figure. Likelihoods are calculated for the separated stroke groups. The likelihood includes, for example, a character likelihood indicating a likelihood of a character, a figure likelihood indicating a likelihood of a figure, and the like, and may be calculated using a complexity (to be described later). A complexity not less than a threshold is used as a character likelihood, and a figure likelihood is set to be zero. When a complexity is not more than the threshold, a reciprocal of the complexity is used as a figure likelihood, and a character likelihood is set to be zero. A relation between input stroke groups is determined so that a stroke group having a higher text/figure likelihood has a higher hierarchical relation (layer) with respect to a display plane. Thus, even for stroke data, overlapping objects can be manipulated (a target object to be manipulated can be easily and intuitively manipulated without any previous knowledge).

A hierarchical relation can be determined by various methods.

For example, the number of folding points included in a stroke group is calculated as a complexity of the stroke group. When the calculated complexity is not less than a threshold, that complexity is used as an object likelihood.

When the complexity is not more than the threshold, a reciprocal of the complexity is used as an object likelihood. A relation between input stroke groups is decided so that a stroke group having a higher object likelihood has a higher hierarchical relation (layer) with respect to the display plane.

Alternatively, an identifier which has learned in advance to determine if each stroke group belongs to any of prescribed objects such as a character or figure may be used to calculate an object likelihood.

FIG. 8 shows a hierarchical relation determination sequence example.

In step S21, stroke data are separated into a stroke group which forms an object.

In step S22, a complexity of the object is calculated.

It is determined in step S23 whether or not the complexity is not less than a threshold. If the complexity is not less than the threshold, the process advances to step S24; otherwise, the process advances to step S25.

In step S24, the stroke group is registered in a highest layer.

In step S25, the stroke group is registered in a closest lower layer with a lower complexity.

Note that this processing is an example, and this embodiment is not limited to this.

The determined hierarchical relation may be held in data of stroke groups. In addition to or in place of such data, a layer information database which is independent of the data of stroke groups and indicates the hierarchical relation between objects may be held. FIG. 1 exemplifies a case including the layer information database 13.

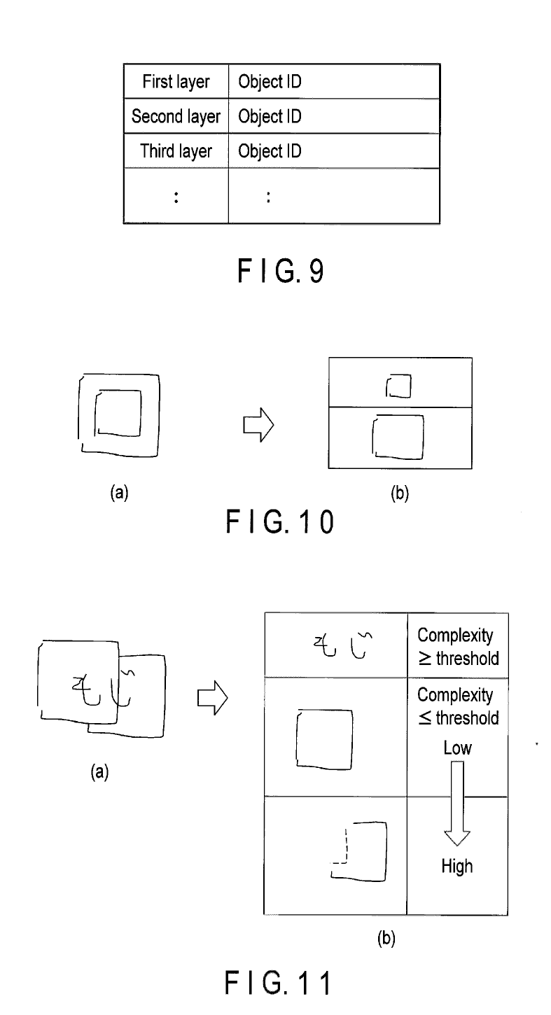

FIG. 9 shows an example of layer information.

For example, in the example of FIG. 6, an object ID of the object 1001 is registered in a first layer, that of the object 1002 is registered in a second layer, and that of the object 1003 is registered in a third layer.

The object element interpolation unit 24 interpolates a portion of an object when a plurality of stroke groups have a predetermined relation. The predetermined relation of the plurality of stroke groups is, for example, an inclusion relation, intersection relation, adjacency relation, or the like. For example, a case will be assumed wherein a portion of a relatively lower object is occluded behind another relatively higher object. The stroke groups have an intersection or adjacency relation. In this case, the occluded portion of the relatively lower object normally means a rectangle or the like for the user. That is, some of stroke data do not exist. The object element interpolation unit 24 interpolates the occluded portion. That is, the object element interpolation unit 24 generates data of that portion.

More specifically, in the example of FIG. 6, a portion of the object 1003, which is occluded behind the object 1002, is interpolated, and the object 1003 is handled as a rectangle, as shown in (b).

An example of hierarchical relation determination criteria will be described below.

Various hierarchical relation determination criteria may be used. Also, the user may arbitrarily select from a plurality of criteria.

For example, the following criteria may be used:
an object having a later input time is registered in a higher layer;
an included object is registered in a higher layer;
when a complexity of a shape defined by the number of folding points of strokes is not less than the threshold, a corresponding object is judged as a character and is registered in a higher layer; an object having the complexity not more than the threshold is judged as a figure and is registered in a lower layer in descending order of complexity;
an object having a higher character likelihood is registered in a higher layer;
an object having a higher figure likelihood is registered in a higher layer;
a closed figure object is registered in a higher layer than an open figure object;
a figure object, two end points of which are connected to a closed figure object, is registered in a lower layer than the closed figure object; and so forth.

FIG. 10 shows a hierarchical relation determination example. (a) shows a handwritten object, and (b) shows layer information.

When a closed figure object includes another closed figure object, as shown in (a), the included object is registered in a higher layer, as shown in (b).

FIG. 11 shows another hierarchical relation determination example.

When a character object, a closed figure object, and open figure object overlap each other, as shown in (a), if there is an object having a complexity not less than a threshold, that object (the character object in the example of FIG. 11) is registered in a highest layer, and as for objects having complexities not more than the threshold, an object having a lower complexity is registered in a higher layer, as shown in (b).

Also, a character likelihood or figure likelihood may be calculated by an identifier which is learned in advance.

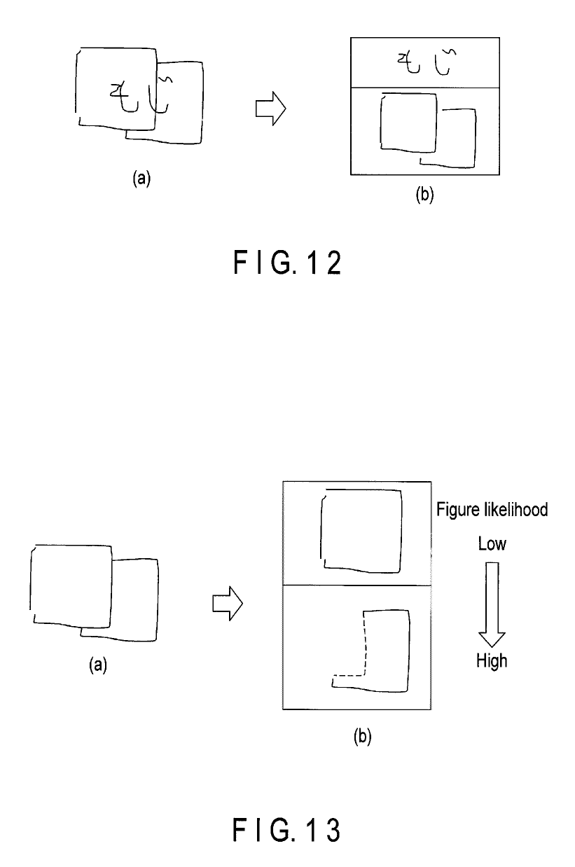

FIG. 12 shows still another hierarchical relation determination example.

When a character object, a closed figure object, and open figure object overlap each other, as shown in (a), the object having a high character likelihood is registered in a higher layer, and other objects are registered in a lower layer.

FIG. 13 shows yet another hierarchical relation determination example.

When a closed figure object and open figure object overlap each other, as shown in (a), the object having a higher figure likelihood (in this example, the closed figure object) is registered in a higher layer.

Also, for example, upon determination of a hierarchical relation, a relation between objects may be used along with character and figure likelihoods. For example, when objects have an inclusion or intersection relation, layers of the objects having such relation may be adjacent to each other.

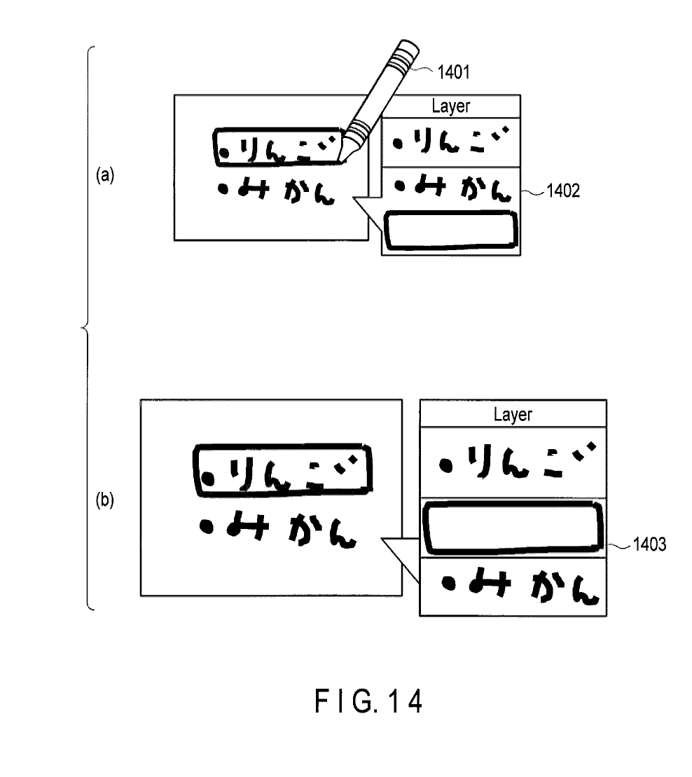

FIG. 14 shows an example of hierarchical relation determination and layer information.

For example, when there are a first character object [ [symbol] ] ([ [symbol] ] means “apple” in English) and a second character object [ [symbol] ] ([ [symbol] ] means “orange” in English), and a frame which surrounds the first character object [ [symbol] ] is handwritten, as shown in (a) (see reference numeral 1401), a figure object indicating the frame which surrounds the first character object [ [symbol] ] is generated as a new stroke group. At this time, when a lowest layer is assigned to the new figure object, as denoted by reference numeral 1402, separated layers are assigned to the first character object and the new figure objects. Hence, since the new figure object has an inclusion or intersection relation with the first character object [ [symbol] ], the new figure object may be inserted in a layer immediately below the first character object [ [symbol] ] having a stronger relation, as denoted by reference numeral 1403 in (b).

Another example of stroke group generation and attribute extraction methods will be described below.

A handwritten document is separated into character parts and figure parts.

An internal part of each “character part” may further be separated into a plurality of parts.

An example of the separation processing will be described below. A handwritten document is separated into units of a character part, a graphic part and a table part.

For example, using a classifier which is pre-learnt to determine which of a character, a graphic and a table each of strokes belongs to, the likelihood is calculated with respect to each stroke and is expressed by Markov random field (MRF) in order to couple with spatial proximity and continuity on a document plane. Strokes may be separated into a character part, a graphic part and a table part (see, e.g. X.-D. Zhou, C.-L. Liu, S. Ouiniou, E. Anquetil, “Text/Non-text Ink Stroke Classification in Japanese Handwriting Based on Markov Random Fields” ICDAR '07 Proceedings of the Ninth International Conference on Document Analysis and Recognition, vol. 1, pp 377-381, 2007).

The classification into the character part, graphic part and table part is not limited to the above method.

The stroke group data generation processing from ink data has been mainly described so far. Processing for stroke groups will be mainly described below. Note that stroke groups to be processed may be those which are generated by, for example, the stroke group data generation unit 2 shown in FIG. 1 or those which are externally acquired.

The stroke group processing unit 3 will be described below.

The stroke group processing unit 3 can include one or a plurality of various processing units required to execute the processing associated with objects (stroke groups). FIG. 1 shows, for example, the layer processing unit 31 which executes processing associates with layers between a plurality of objects, and the execution unit 32 which executes predetermined processing for a designated object (however, this embodiment is not limited to this).

The predetermined processing for stroke groups includes various processes. For example, the predetermined processing includes shaping processing, editing processing, drawing processing, interpolation processing, search processing, and the like.

The layer processing unit 31 executes processing associated with layers of a plurality of objects having an inclusion or intersection relation. For example, such processing includes that for specifying a designated object of the plurality of objects having the inclusion or intersection relation, that for changing a hierarchical relation of these plurality of objects, and the like.

The execution unit 32 executes the predetermined processing for the designated object.

Note that the stroke group processing unit 3 may use the hierarchical relation determination unit 23 and object element interpolation unit 24 shown in FIG. 1 as needed. Alternatively, the stroke group processing unit 3 may uniquely include a hierarchical relation determination unit and object element interpolation unit.

Some processing sequence examples of the stroke group processing unit 3 will be described below.

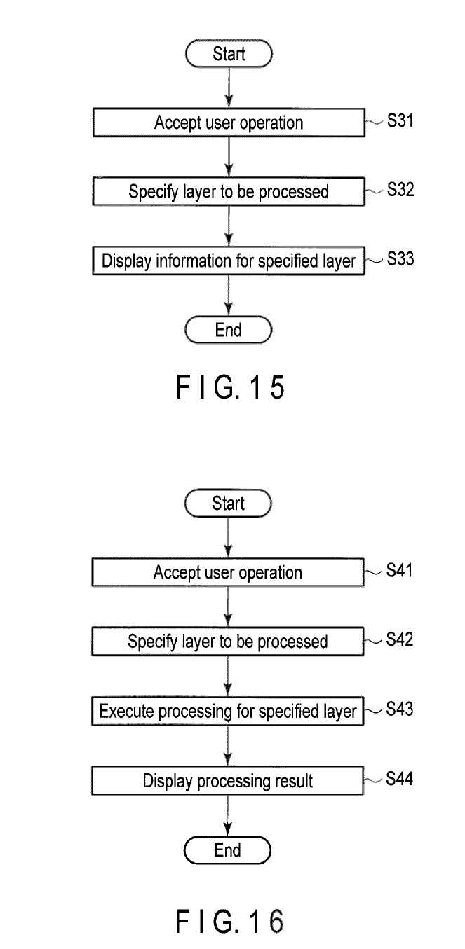

FIG. 15 shows an example of the processing of stroke group processing unit 3.

The stroke group processing unit 3 accepts a user operation in step S31, specifies a layer to be processed based on the user operation in step S32, and presents information associated with the specified layer in step S33.

FIG. 16 shows another example of the processing of stroke group processing unit 3.

The stroke group processing unit 3 accepts a user operation in step S41, specifies a layer to be processed based on the user operation in step S42, executes processing for the specified layer in step S43, and presents a processing result in step S44.

Note that FIGS. 15 and 16 are examples, and various other processing sequences are available.

Some examples of processing for stroke groups will be described below.

<Example of Figure Shaping>

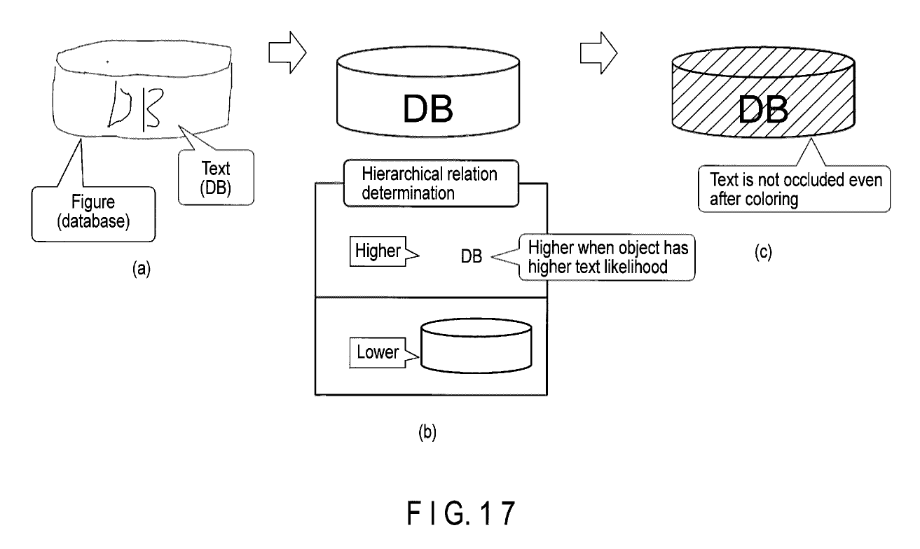

FIG. 17 shows an example of figure shaping processing.

Assume that handwritten strokes are input, as shown in (a).

From these strokes, a figure object and a character object are discriminated and generated. Also, a hierarchical relation of these figure and character objects with respect to the display plane is determined. A higher layer is assigned to the character object, and layer information is held. Furthermore, shaping processing is executed. (b) shows this result. The shaped data may undergo format conversion for another software application.

Also, a relation in which the character object is included in the figure object may be discriminated. Conveniently, when the inclusion relation is apparent, it is easy to apply the character object to the higher layer.

For example, the above data may be applied to secondary use. For example, even when the figure object in a lower layer may be colored, the character object in the higher layer is not occluded, as shown in (c).

<Example of Figure Editing/Figure Shaping>

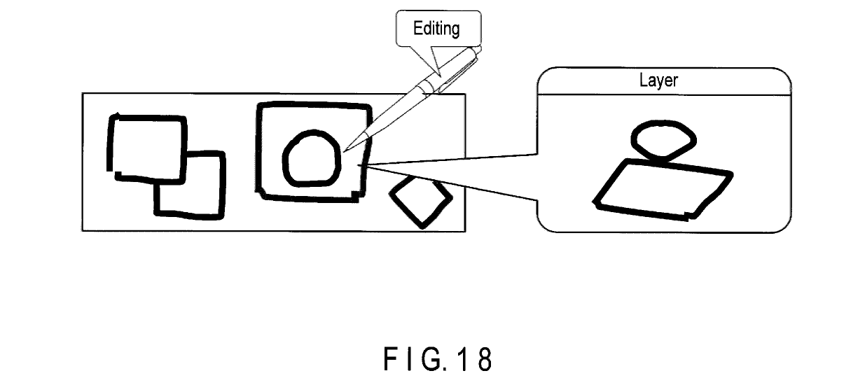

FIG. 18 shows an example of figure editing/figure shaping processing.

For example, even when strokes do not overlap each other, when planes of recognized objects have an overlapping, they are displayed.

For example, as shown in FIG. 18, when the user is about to manipulate a region of overlapping objects, a layer relation may be presented to the user.

There are various methods of presenting the layer relation. For example, layer information may be displayed, as shown in FIG. 14, or related objects may be three-dimensionally displayed, as shown in FIG. 18.

<Example of Figure Editing/Figure Shaping>

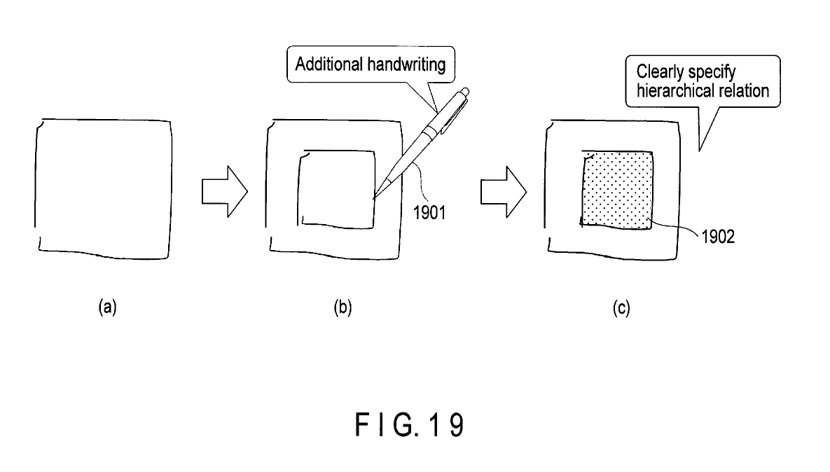

FIG. 19 shows another example of figure editing/figure shaping processing.

For example, when the user further handwrites a figure object, as shown in (b), inside a figure object shown in (a) (see reference numeral 1901), the figure object in a higher layer is colored, as shown in (c), thus presenting the layer relation to the user. Note that this coloring may be temporarily made.

<Example of Figure Editing/Drawings>

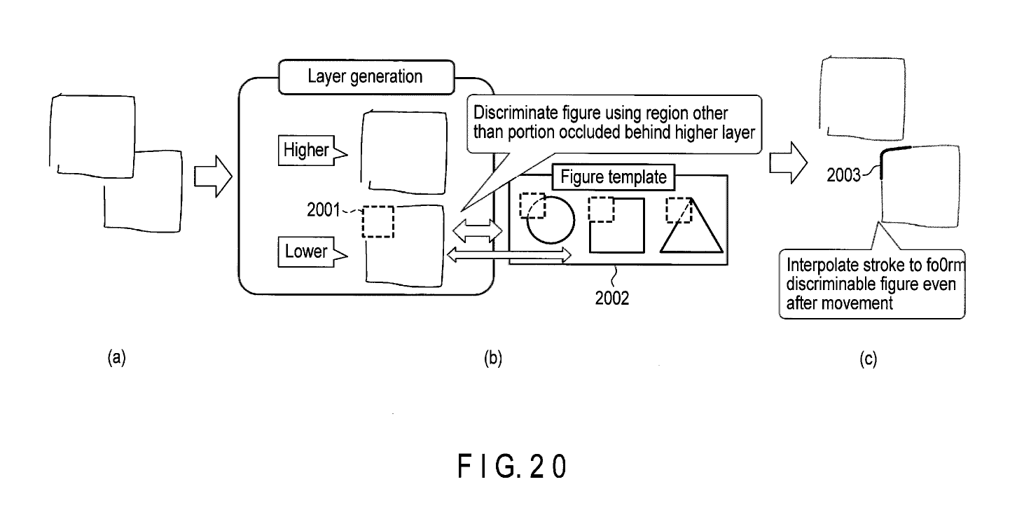

FIG. 20 shows an example of figure editing/drawing processing.

For example, assume that a closed figure object and an open figure object overlap each other, as shown in (a). Then, a higher layer is assigned to the closed figure object, as shown in (b).

In this case, an occluded portion of a lower layer figure may be discriminated or estimated using a region other than an overlying portion of the higher layer.

For example, a deficient portion (see reference numeral 2001) of the open figure object may be interpolated using a figure template (see reference numeral 2002). For example, the open figure object is interpolated to form a rectangle (see reference numeral 2003), as shown in (c).

In this manner, a stroke of the lower layer figure can be automatically interpolated. Then, as shown in (c), even when the higher layer is moved, the occluded portion of the lower layer figure appears by interpolation.

<Example of Figure Drawing>

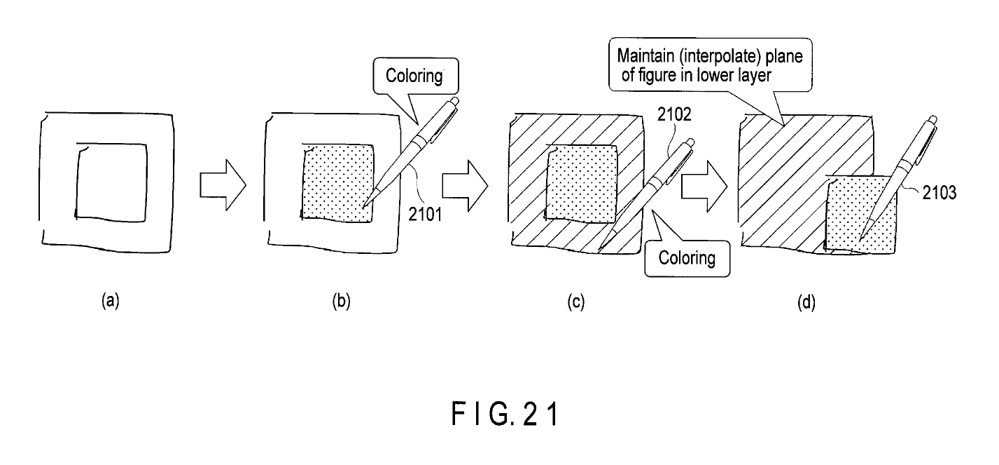

FIG. 21 shows an example of figure drawing processing.

For example, as shown in (a), when a figure object includes another figure object, coloring is made in turn, as shown in (b) and (c) (see reference numerals 2101 and 2102). In this case, a surface of the figure object in a lower layer may be maintained (interpolated). That is, an occluded portion of the figure object in the lower layer can be colored. Even when the user moves the object of a higher layer, as shown in (d), a portion of the object that appears in the lower layer has been colored (see reference numerals 2103).

<Example of Figure Drawing (Online)>

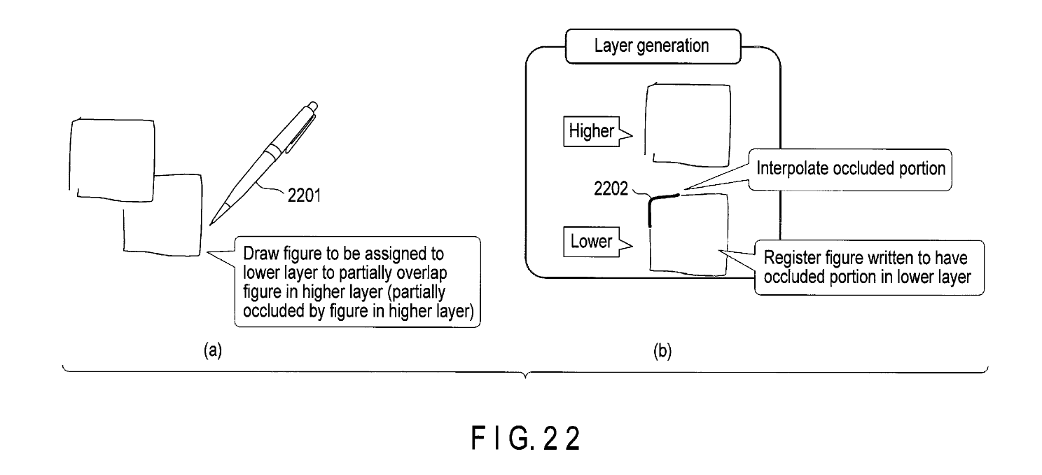

FIG. 22 shows an example of figure drawing (online figure drawing) processing.

For example, when there is one figure object, and the user wants to write another figure object in a lower layer of the former object, he or she writes the figure to be written in the lower layer so that two end points of its portion are connected to the existing figure, as shown in (a) (see reference numeral 2201). Thus, the lower layer is assigned to the added figure, and a portion which is written to be occluded can be interpolated (see reference numeral 2202). In general, when a portion of a figure is occluded behind a figure in a higher layer, that figure appears to be in a relatively lower layer. Using the layer relatively located in the lower layer, the occluded portion is interpolated, as described above, thus presenting the figure intended by the user.

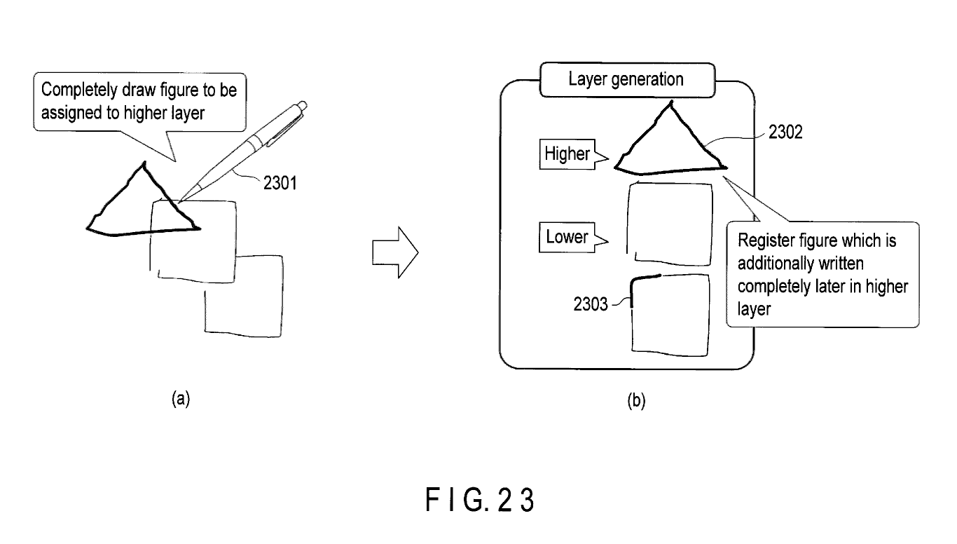

FIG. 23 shows another example of figure drawing processing.

In the state of (a) of FIG. 22, when the user wants to add another figure object to a higher layer, he or she draws a closed figure (see reference numeral 2301) on the figure to be superposed, as shown in (a) of FIG. 23. Thus, the figure which is additionally written later completely can be registered in the highest layer, as shown in (b).

<Example of Editing>

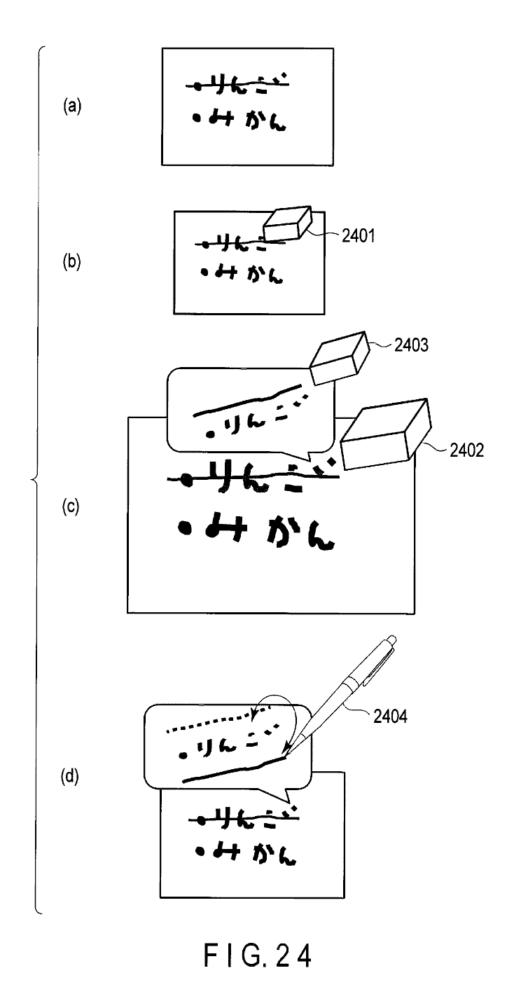

FIG. 24 shows an example of editing processing.

For example, assume that there are a first text object [ [symbol] ], second text object [ [symbol] ], and a figure object which indicates a strike-through with respect to the first text object [ [symbol] ], as shown in (a). Conventionally, when a portion of the first text object [ [symbol] ] and the figure object “strike-through” are erased by an electronic eraser (2401), the portion of the first text object [ [symbol] [symbol] ] and the figure object “strike-through” is simultaneously erased. According to this embodiment, since the first text object [ [symbol] ] and figure object “strike-through” are registered in different layers, as shown in (c), when the user selects a layer to be an operational target, he or she can erase one of the first text object [ [symbol] ] and figure object “strike-through”. Also, by selecting a layer to be an operational target, the user can move one of the first text object [ [symbol] ] and figure object “strike-through”. “ [symbol] ” and “ [symbol] ” are handwritten character strings, but this embodiment is not limited only a character string.

Next, variations of the present embodiment are described.

The stroke group processing unit 3 of handwriting drawing apparatus of the embodiment may use, as targets, handwritten documents which are stored in the handwriting drawing apparatus. Alternatively, when the handwriting drawing apparatus is connectable to a network such as an intranet and/or the Internet, the stroke group processing unit 3 may use, as targets, handwritten documents which can be accessed via the network. Alternatively, the stroke group processing unit 3 may use, as targets, handwritten documents which are stored in a removable memory that is connected to the handwriting drawing apparatus. Besides, targets may be an arbitrary combination of these handwritten documents. It is desirable that as regards these handwritten documents, at least the same likelihoods as the likelihoods, which are used in the embodiment, are associated and stored.

The handwriting drawing apparatus of the embodiment may be configured as a stand-alone apparatus, or may be configured such that the handwriting drawing apparatus is distributed to a plurality of nodes which are communicable via a network.

The handwriting drawing apparatus of the embodiment can be realized by various devices, such as a desktop or laptop general-purpose computer, a portable general-purpose computer, other portable information devices, an information device with a touch panel, a smartphone, or other information processing apparatuses.

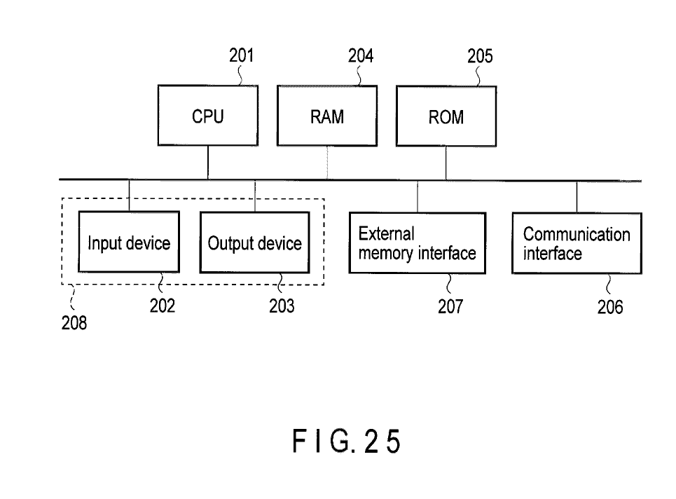

FIG. 25 illustrates an exemplary block diagram of the hardware which realizes the handwriting drawing apparatus of the embodiment. In FIG. 13, numeral 201 is a CPU, 202 is an appropriate input device, 203 is an appropriate output device, 204 is a RAM, 205 is a ROM, 206 is an external memory interface, and 207 is a communication interface. For example, when a touch panel is used, use is made of, for instance, a liquid crystal panel, a pen, and a stroke detector which is provided on the liquid crystal panel (see 208 in FIG. 13).

In addition, for example, a part of the structure of FIG. 1 may be provided on a client, and the other part of the structure of FIG. 1 may be provided on a server.

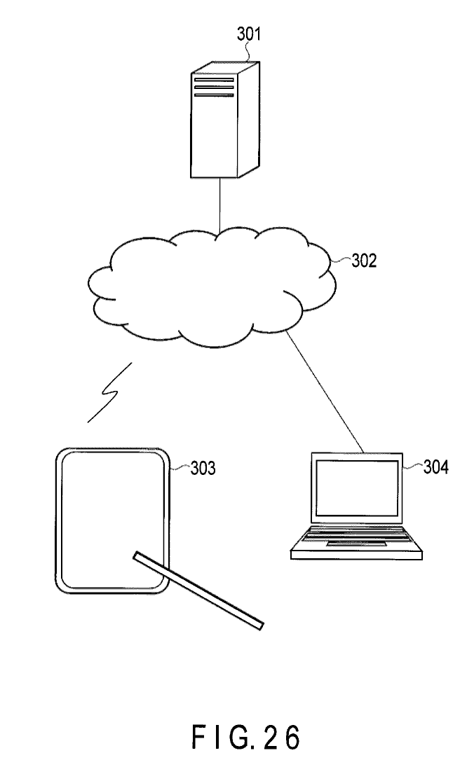

For example, FIG. 26 illustrates a state in which a server 301 exists on a network 302 such as an intranet and/or the Internet, and each client 303, 304 communicates with the server 301 via the network 302, thereby realizing the handwriting drawing apparatus of the embodiment.

The case is illustrated that the client 303 is connected to the network 302 by wireless communication and the client 304 is connected to the network 302 by wired communication.

Usually, the client 303, 304 is a user apparatus. The server 301 may be, for example, a server provided on a LAN such as an intra-company LAN, or a server which is operated by an Internet service provider. Besides, the server 301 may be a user apparatus by which one user provides functions to another user.

Various methods are thinkable as a method of distributing the structure of FIG. 1 to a client and a server.

For example, in FIG. 1, the range indicated by 102 may be mounted on the client side, and the other range may be mounted on the server side. Alternatively, only the stroke group processing unit 3 may be mounted on the server side, and the other range may be mounted on the client side.

Note that an apparatus including the range of 101 in FIG. 1, or an apparatus including a range, which excludes the acquisition unit 1 from 101 in FIG. 1, may be realized. In this case, thes apparatus has a function of generating data of stroke groups from a stroke sequence. In addition, for example, the range indicated by 102 in FIG. 1 may be mounted on the client side, the stroke group processing unit 3 may be mounted on a first server, and the range, which excludes the stroke acquisition unit 1 from 101, may be mounted on a second server.

Other distribution methods are also possible.

As described above, according to this embodiment, objects can be processed more effectively by taking a hierarchical relation of a plurality of handwritten objects into consideration.

The instructions included in the procedures in the above-described embodiments can be executed based on a program as software. Further, the same advantage as obtained by the handwriting drawing apparatus of the embodiments can also be obtained by beforehand storing the program in a versatile computing system and reading it. The instructions described in the above-described embodiments are recorded, as a program for causing a computer to execute them, on a recording medium, such as a magnetic disk (a flexible disk, a hard disk, etc.), an optical disk (a CD-ROM, a CD-R, a CD-RW, a DVD-ROM, a DVD±R, a DVD±RW, etc.), a semiconductor memory, or a recording medium similar to them. The recording scheme employed in the recording mediums is not limited. It is sufficient if the computer or a built-in system can read the same. If the CPU of the computer reads the program from the recording medium and executes the instructions written in the program, the same function as in the handwriting drawing apparatus of the embodiments can be realized. It is a matter of course that the computer acquires the program via a network.

Further, the OS (operating system) operating on the computer, database management software, middleware such as a network, etc., may execute part of each process for realizing the embodiments, based on the instructions in the program installed from a recording medium into the computer or the built-in system.

Yet further, the recording medium in the embodiments is not limited to a medium separate from the computer or the built-in system, but may be a recording medium into which a program acquired via a LAN, the Internet, etc., is stored or temporarily stored.

In addition, a plurality of mediums, from which programs are read to execute the process steps of the embodiments, may be employed.

The computer or the built-in system in the embodiments are used to execute each process step in the embodiments based on the program stored in the recording medium, and may be a personal computer or a microcomputer, or be a system including a plurality of apparatuses connected via a network.

The computer in the embodiments is not limited to the above-mentioned personal computer, but may be an operational processing apparatus incorporated in an information processing system, a microcomputer, etc. Namely, the computer is a generic name of a machine or an apparatus that can realize the functions of the embodiments by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A handwriting drawing apparatus comprising:
a stroke acquisition unit configured to acquire stroke data;
a stroke group generation unit configured to generate stroke groups each including one or a plurality of strokes, which satisfy a predetermined criterion, based on the stroke data; and
a hierarchical relation determination unit configured to determine a hierarchical relation of a plurality of stroke groups so as to generate layer information.

2. The apparatus of claim 1, wherein the hierarchical relation determination unit calculates a likelihood as character or figure for each stroke group, and determines the hierarchical relation based on the calculated likelihood.

3. The apparatus of claim 2, wherein the likelihood is a complexity of the stroke group, and when the complexity of the stroke group is higher than a threshold, a higher layer is assigned to the stroke group.

4. The apparatus of claim 3, wherein when the complexity of the stroke group is lower than the threshold, a lower layer is assigned to the stroke group as the complexity is higher.

5. The apparatus of claim 1, wherein when the two stroke groups have an inclusion relation, the hierarchical relation determination unit assigns a higher layer to the included stroke group.

6. The apparatus of claim 1, further comprising a stroke group processing unit configured to specify a layer to be an operational target based on the layer information, and to execute processing for the stroke group corresponding to the specified layer.

7. The apparatus of claim 6, wherein the processing includes shaping processing, editing processing, or drawing processing for a figure.

8. The apparatus of claim 1, further comprising a display unit configured to display correspondence between the plurality of stroke groups and the hierarchical relation indicated by the layer information.

9. The apparatus of claim 1, further comprising an interpolation unit configured to interpolate a portion of a stroke group, which intersects with a stroke with which a higher layer is assigned, and is assigned with a lower layer, of the plurality of stroke groups.

10. The apparatus of claim 9, wherein the interpolation unit executes the interpolation using a figure template which is prepared in advance.

11. A handwriting drawing method of a handwriting drawing apparatus, comprising:
acquiring, at the handwriting drawing apparatus, stroke data;
generating, at the handwriting drawing apparatus, stroke groups each including one or a plurality of strokes, which satisfy a predetermined criterion, based on the stroke data; and
determining, at the handwriting drawing apparatus, a hierarchical relation of a plurality of stroke groups so as to generate layer information.

12. A non-transitory computer-readable medium storing a computer program which is executed by a computer to provide steps of:
acquiring stroke data;
generating stroke groups each including one or a plurality of strokes, which satisfy a predetermined criterion, based on the stroke data; and
determining a hierarchical relation of a plurality of stroke groups so as to generate layer information.
